(19) United States
(12) Patent Application Publication
(10) Pub. No.: US 2001/0043680 A1
(43) Pub. Date: Nov. 22, 2001

(54) APPARATUS FOR AND METHOD OF AUTOMATICALLY ANSWERING AN INCOMING TELEPHONE CALL AND PROVIDING A SCREENING MESSAGE TO CALLER

(76) Inventor: RICHARD K. SCHEEL, PLEASANTON, CA (US)

Correspondence Address: JONATHAN O OWENS, HAVERSTOCK AND OWENS, SUITE 420, 260 SHERIDAN AVENUE, PALO ALTO, CA, 94306

(21) Appl. No.: 09/128,192

(22) Filed: Aug. 3, 1998

(51) Int. Cl. H04M 1/64

(52) U.S. Cl. 379/70; 379/88.12

(57) ABSTRACT

An automated answering message system allows a user to cause a telephone to answer an incoming call automatically with a recorded message. The recorded message notifies the caller that the user is currently in a meeting or otherwise busy and wishes to be interrupted only for urgent or very important telephone calls. The caller is then given the option of interrupting the user, if the call is urgent, or hanging up. Preferably, the caller will signal that this is an urgent telephone call by entering a code specified in the message using the keypad of their telephone. Once this code is entered by the caller, the telephone is caused to notify the user of the call. The user is then connected to the call in a conventional manner. The automated answering message system is preferably activated and deactivated by a switch on the telephone. Alternatively, the automated answering message system is activated and deactivated through the telephone's keypad. When the automated answering message system is deactivated, the telephone will function in its normal manner, ringing for each incoming call until answered.

### FIELD OF THE INVENTION

The present invention relates to the field of telephones and telephone answering systems. More particularly, the present invention relates to the field of automatically answering an incoming call and providing a message to a caller.

### BACKGROUND OF THE INVENTION

Cellular telephones provide convenience and safety to users by giving the users the ability to make and receive calls from any location where cellular service is available. The ability to receive calls on a cellular telephone is limited to the times when the telephone is turned on. When the telephone is turned off, a caller will normally receive a message provided by the cellular service provider that the user is currently unavailable or is not within a service area. With some systems, a caller calling when a user's telephone is turned off will be able to leave a voice message for the user with the service provider. The user can then retrieve such a message by calling into the service provider.

While it is important for a user of a cellular telephone to be reachable for important calls, there are times and locations where receiving such an incoming call is disruptive and inappropriate. One example of such a location is a meeting being attended by the user. While it may be necessary for the user to have their telephone turned on during attendance of a meeting, having the telephone ring in the middle of the meeting can be very disruptive to the meeting and the other participants. However, even at such times it may still be necessary for the user to accept urgent or very important telephone calls regardless of the disruption the calls may cause. Currently, in order to accept such calls, the user must have their telephone turned on, causing the telephone to also accept calls that are not urgent.

With conventional telephone sets in homes and offices there are also times when the user may want to accept only urgent or very important incoming telephone calls. During such times the user may not want the telephone to ring for every incoming call, but only those calls which are urgent or very important.

What is needed is a method of automatically answering an incoming telephone call and notifying the caller that the user is busy and is requesting that only urgent calls are put through to the user. What is further needed is a method of notifying the user only of urgent telephone calls when they are in a meeting or otherwise busy.

### SUMMARY OF THE INVENTION

An automated answering message system allows a user to cause a telephone to answer an incoming call automatically with a recorded message. The recorded message notifies the caller that the user is currently in a meeting or otherwise busy and wishes to be interrupted only for urgent or very important telephone calls. The caller is then given the option of interrupting the user, if the call is urgent, or hanging up. Preferably, the caller will signal that this is an urgent telephone call by entering a code specified in the message using the keypad of their telephone. Once this code is entered by the caller, the telephone is caused to notify the user of the call. The user is then connected to the call in a conventional manner. The automated answering message system is preferably activated and deactivated by a switch on the telephone. Alternatively, the automated answering message system is activated and deactivated through the telephone's keypad. When the automated answering message system is deactivated, the telephone will function in its normal manner, ringing for each incoming call until answered.

### BRIEF DESCRIPTION OF THE DRAWINGS

FIG. 1 illustrates a block diagram schematic of the components within a telephone of the preferred embodiment of the present invention.

FIG. 2 illustrates a block diagram schematic of the components within an alternate embodiment of the telephone of the present invention.

FIG. 3 illustrates a flow diagram of the steps involved in automatically answering an incoming call according to the preferred embodiment of the present invention.

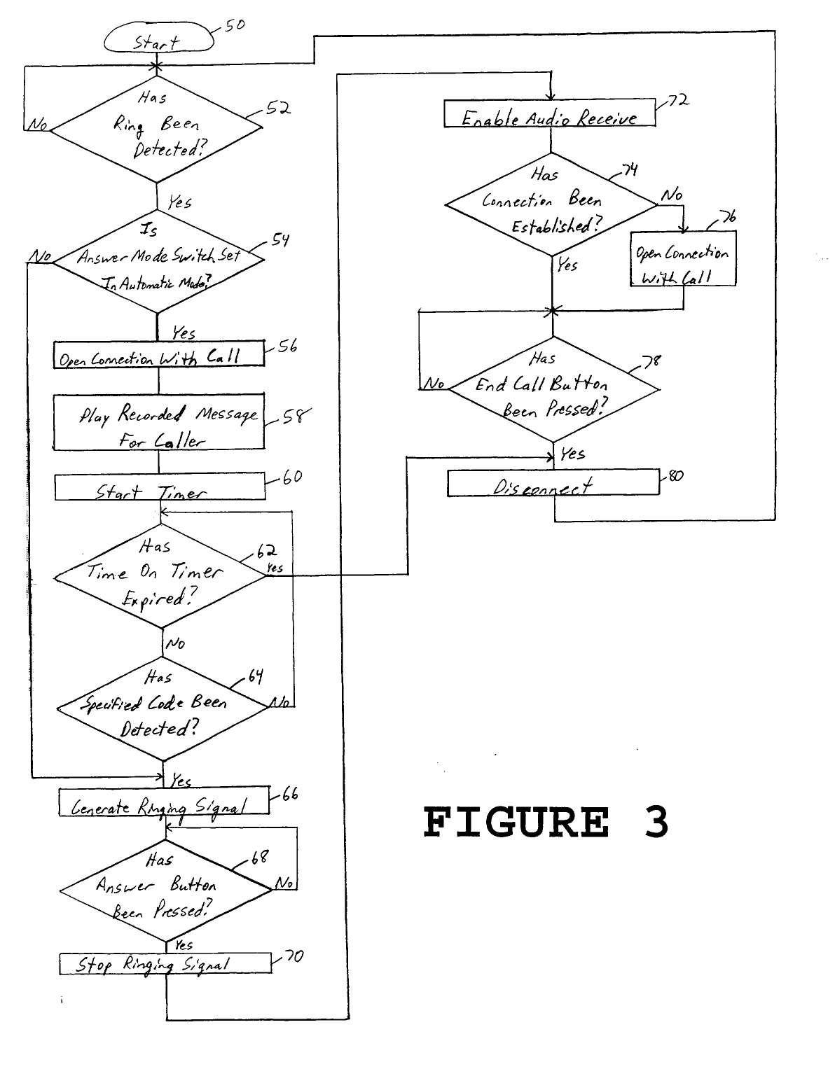

### DETAILED DESCRIPTION OF THE PREFERRED EMBODIMENT

An apparatus for automatically answering an incoming telephone call and providing a status message to the caller allows a user to cause a telephone to answer an incoming call automatically with a recorded message. The recorded message notifies the caller that the user is currently in an inappropriate setting in which to answer the call and wishes to receive only urgent and very important telephone calls. The caller is then given the option of interrupting the user or hanging up. Preferably, if the caller decides to interrupt the user, the caller will signal that the call is to be put through to the user by entering a specified code using the keypad of their telephone. Once this code is detected by the telephone, the telephone will notify the user of the call. The user is then connected to the call in a conventional manner.

The automated answering and message system of the preferred embodiment of the present invention is activated and deactivated by an external switch on the telephone. Alternatively, the automated answering and message system is activated and deactivated using the telephone's keypad.

When the automated answering message system is deactivated, the telephone will function in its normal manner, ringing until answered. The preferred embodiment of the automated answering message system is implemented within a cellular telephone. However, as should be apparent to those skilled in the art, alternatively the automated answering message system of the present invention can be implemented on any telephone. In a further alternate embodiment, the telephone is equipped with a light which flashes and/or a vibrating device which causes the telephone to vibrate when the caller has entered the code for an urgent call. The flashing light and the vibrating device are activated to silently alert the user that there is an urgent incoming telephone call.

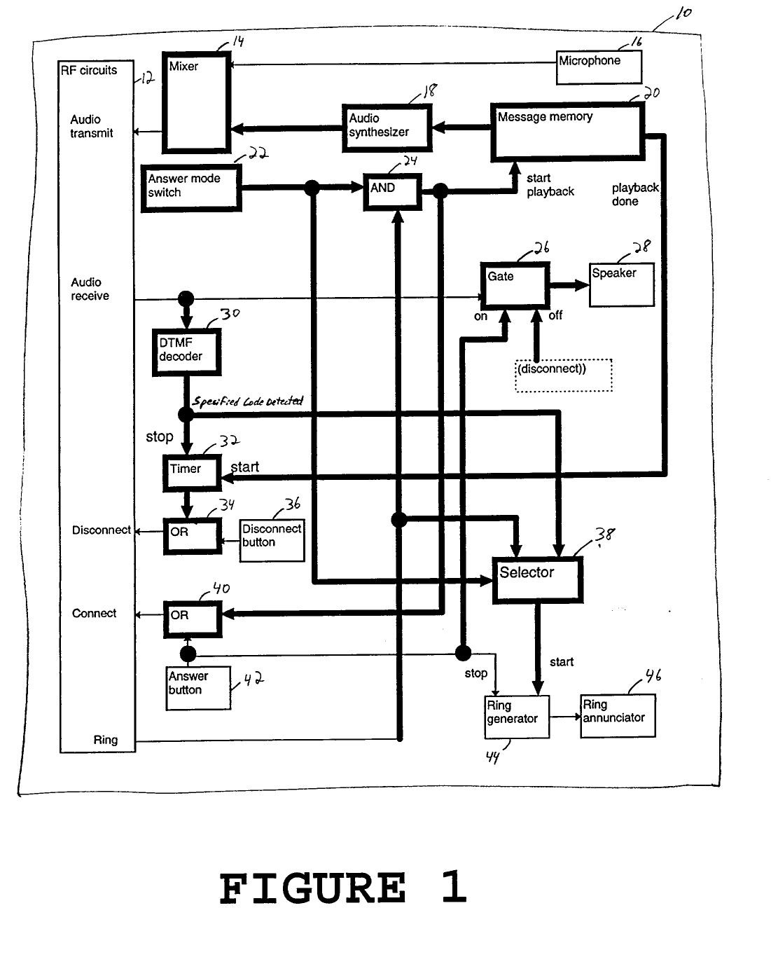

A block diagram schematic of the components within a telephone of the preferred embodiment of the present invention is illustrated in FIG. 1. Within the telephone 10, the radio frequency circuits 12 control the telephony functions of detecting a call, initiating a ring sequence, connecting to the call when answered, transmitting and receiving audio information and disconnecting from the call. The ring signal is generated by the radio frequency circuits 12 and is coupled as an input to the logical AND gate 24 and to the selector circuit 38. An output from an answer mode switch 22 is also coupled as an input to the logical AND gate 24 and to the selector circuit 38. The output from the answer mode switch 22 is maintained at a logical high voltage level if the user has switched the answer mode switch 22 to the automatic mode, which thereby activates the automated answering and message system of the present invention. The output from the answer mode switch 22 is at a logical low voltage level if the user has switched the answer mode switch 22 to the normal mode, which allows the telephone to ring until answered. Preferably, the answer mode switch 22 is an external switch on the telephone. Alternatively, the answer mode switch 22 is an internal switch which is controlled by the user through the telephone's keypad.

An output of the logical AND gate 24 is coupled to a logical OR gate 40 and to a message memory 20 in order to cause the incoming call to be answered and activate playback of a recorded message stored in the memory 20 if the answer mode switch 22 is in the automatic mode. An output from an answer button 42 is coupled as an input to the logical OR gate 40, to a ring generator circuit 44 and as an on input to a gate circuit 26. An output of the logical OR gate 40 is coupled to the radio frequency circuits 12 to answer and connect to an incoming call. The answer button 42 is activated by the user and causes the incoming call to be answered. The message memory 20 is preferably a non-volatile memory which stores the message for playback in a digital form. An output of the message memory 20 is coupled to an audio synthesizer 18 for synthesizing the message output from the message memory 20 thereby forming an audio signal which is output by the audio synthesizer 18. An output of the audio synthesizer 18 is coupled to an input of a mixer circuit 14. An output of the mixer circuit 14 is coupled to an audio transmit circuit within the radio frequency circuits 12. A microphone 16 is also coupled as an input to the mixer circuit 14. A playback done output signal from the message memory 20 is coupled as a start input to a timer circuit 32.

An audio receive output from the radio frequency circuits 12 is coupled as an input to the gate circuit 26 and to a dual tone multi frequency (DTMF) decoder circuit 30. An output of the DTMF decoder circuit 30 is coupled as a stop input to the timer circuit 32 and as an input to the selector circuit 38. The DTMF decoder circuit 30 of the preferred embodiment of the present invention will raise its output to a logical high voltage level if it detects the specified code entered by the caller. Preferably, the specified code is a “1.” An output of the timer circuit 32 is coupled as an input to a logical OR gate 34. An output from a disconnect button 36 is also coupled as an input to the logical OR gate 34. An output of the logical OR gate 34 is coupled to the radio frequency circuits 12 to disconnect a call.

The output of the disconnect button 36 is also coupled to an off input of the gate circuit 26. An output of the gate circuit 26 is coupled to an audio speaker 28. The gate circuit 26 is turned on and passes the audio from the audio receive output of the radio frequency circuits 12 to the speaker 28 when the output from the answer button 42 is raised to a logical high voltage level. The gate circuit 26 is turned off and does not pass the audio on the audio receive output of the radio frequency circuits 12 to the speaker 28 when the output from the disconnect button 36 is raised to a logical high voltage level.

The output from the answer mode switch 22 controls the operation of the selector circuit 38. If the answer mode switch 22 is switched to the normal mode, the output from the answer mode switch 22 is pulled to a logical low voltage level and the selector circuit 38 will pass through the ring signal generated by the radio frequency circuits 12. Otherwise, if the answer mode switch 22 is switched to the automatic mode, the output from the answer mode switch 22 is raised to a logical high voltage level and the selector circuit 38 will pass through the output from the DTMF decoder circuit 30.

An output of the selector circuit 38 is coupled to a start input of the ring generator circuit 44. When the telephone is in the automatic mode, an output of the selector circuit 38 is raised to a logical high voltage level if the specified code is detected by the DTMF decoder circuit 30. When the telephone is not in the automatic mode, the output of the selector circuit 38 is raised to a logical high voltage level if the ring signal is generated by the radio frequency circuits 12 after an incoming call is detected. An output of the ring generator circuit 44 is coupled to the ring annunciator circuit 46 to generate an audible ringing signal. The output of the ring generator circuit 44 will cause the ring annunciator circuit 46 to produce the audible ringing signal when the output of the selector circuit 38 is raised to a logical high voltage level. The output of the ring generator circuit 44 will cause the ring annunciator circuit 46 to stop the audible ringing signal when the answer button 42 is pressed and the user is answering an incoming telephone call.

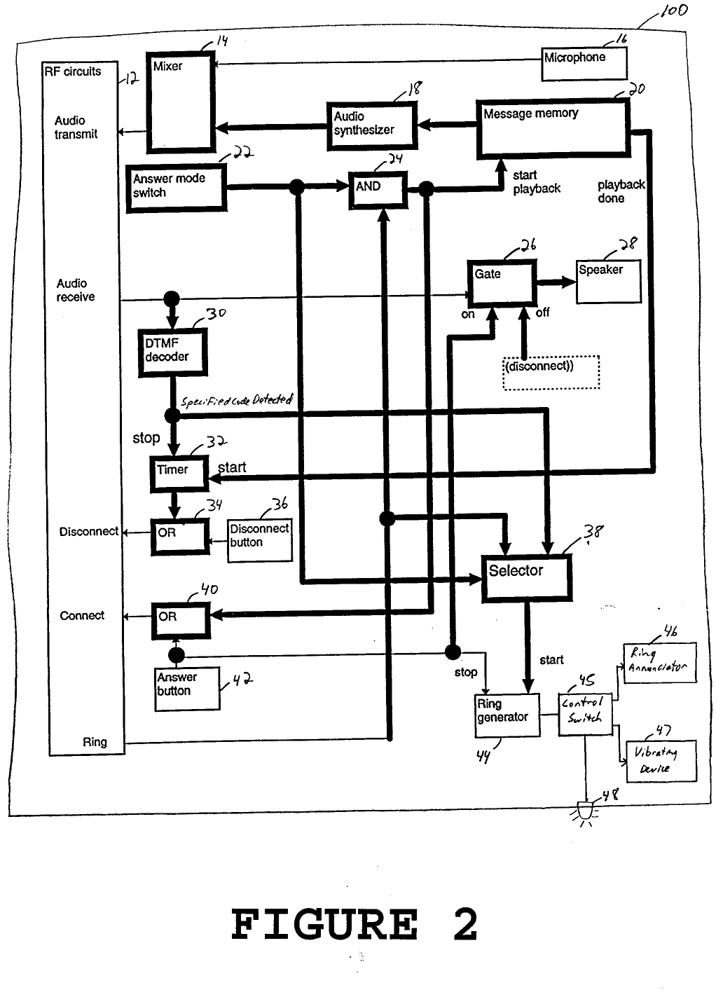

A block diagram schematic of an alternate embodiment of the telephone of the present invention is illustrated in FIG. 2. This embodiment of the telephone 100 includes all of the components of the telephone 10 as illustrated in FIG. 1, with the addition of the control switch 45, the vibrating device 47 and the light 48. The control switch 45 is coupled to receive the output from the ring generator circuit 44. The control switch 45 enables the user to choose how they wish to be notified of an incoming call. Preferably, the control switch 45 is an external switch on the telephone 100. Alternatively, the control switch 45 is an internal switch which is controlled by the user through the telephone's keypad. Through the control switch 45, the user can select to receive notification through any one or a combination of the ring annunciator 46, the vibrating device 47 and the light 48. When the output of the selector circuit 38 is raised to a logical high voltage level, the ring generator circuit 44 will activate its output and the control switch 45 will activate the output or outputs corresponding to the selected one or ones of the ring annunciator 46, the vibrating device 47 and the light 48. When activated by the control switch 45, the ring annunciator 46 will generate an audible ringing noise. When activated by the control switch 45, the vibrating device 47 will cause the telephone to vibrate. When activated by the control switch 45, the light 48 will flash. In this embodiment, when the answer button 42 is pressed, the stop input of the ring generator circuit 44 is activated. This causes the ring generator circuit 44 to stop driving the notification device (annunciator 46, vibrator 47 or light 48) that is selected by the control switch 45.

A flow diagram of the steps involved in automatically answering an incoming call and providing a message to the caller according to the present invention, is illustrated in FIG. 2. The flow chart is entered at the step 50, when the telephone is turned on. The telephone then waits at the step 52 until a ring from an incoming call is detected. Once a ring from an incoming call is detected, the telephone then determines at the step 54, if the telephone is in the automatic answering mode. If the telephone is not in the automatic answering mode, the system jumps to the step 66 and the incoming call is not automatically answered and will continue to ring until answered by the user. Otherwise, if the telephone is in the automatic answering mode, the incoming call will be automatically answered and a connection open with the incoming call at the step 56. The recorded message is then played for the caller at the step 58 and the caller is notified that the user wishes to only be disturbed for urgent and very important telephone calls. The timer is then started at the step 60 in order to give the caller time to enter the specified code.

At the step 62, it is determined if the time on the timer has expired. If the time on the timer has expired then the call is disconnected at the step 80. Otherwise, if the time on the timer has not yet expired then it is determined if the caller has entered the specified code at the step 64. If the caller has not yet entered the specified code then the steps 62 and 64 are repeated until either the time on the timer has expired or the specified code has been detected. If the specified code is detected, then at the step 66, the telephone is caused to generate a ringing signal to notify the user that there is an urgent incoming call. Alternatively, any other appropriate notification signal can be used to notify the user of urgent incoming calls. The telephone then waits at the step 68 until the user joins the call by pressing the answer button. Once the user presses the answer button, the ringing signal is stopped at the step 70.

At the step 72, the telephone is configured to answer the incoming call and the gate circuit 26 is enabled to pass the audio from the audio receive output of the radio frequency circuits 12 to the speaker 28. It is then determined, at the step 74, if the step 56 has been executed and a connection opened with the incoming call. If no connection has been opened with the incoming call, the connection is opened at the step 76. After a connection with the incoming call has been established, then the telephone waits at the step 78 and keeps the connection with the incoming call open until the end call button is pressed. Once the end call button is pressed, signalling that the user is terminating the call, the call is disconnected at the step 80 and the telephone returns to the step 52 until a new incoming call is detected.

In the preferred embodiment of the present invention, the message memory 20 is a non-volatile memory in which the user can record a message to be played for callers when a call is automatically answered. Alternatively, the message memory 20 is a fixed read-only memory (ROM) in which a general message is recorded. In this embodiment the user cannot record their own message.

When the telephone of the present invention is in the automatic answering mode and a ring signal is activated, the output of the logical AND gate 24 will rise to a logical high voltage level, thereby causing the message memory 20 to retrieve the recorded message and play it for the caller. The recorded message notifies the caller that the user wishes to only be disturbed with urgent telephone calls and that by pressing the specified code the caller can be connected to the user. When the recorded message is finished, the playback done output signal from the message memory 20 is raised to a logical high voltage level and the timer 32 is started. If the DTMF decoder circuit 30 detects that the caller has pressed a the specified code before the timer expires, then the timer 32 is stopped and the selector circuit 38 outputs a signal having a logical high voltage level which causes the ring generator circuit 44 and the ring annunciator circuit 46 to generate a ringing signal to notify the user of the call. The ringing signal is stopped when the user answers the call by pressing the answer button 42. If the DTMF decoder circuit 30 does not detect that the caller has pressed the specified code before the timer expires, then the timer 32 generates an output signal to the logical OR gate which causes the logical OR gate 34 to raise its output signal to a logical high voltage level thereby disconnecting the call. In this manner, when the telephone is in the automatic mode, the user is only disturbed for calls wherein the caller decides that the call is urgent or very important. When the telephone is in the automatic mode the ringing signal is disabled for all incoming calls, except calls for which the caller enters the specified code, thereby designating the call urgent or very important.

Preferably, the automatic answering and message circuit of the present invention is implemented within a cellular telephone. Alternatively, as should be apparent to those skilled in the art, the automatic answering and message circuit of the present invention can be implemented on any telephone.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

I claim:

1. A method of automatically answering an incoming call on a telephone comprising the steps of:
a. detecting an incoming call;
b. automatically answering the incoming call thereby forming a connection;
c. playing a message over the connection for a caller; and
d. notifying a user of the incoming call only if a specified code is detected.

2. The method as claimed in claim 1 wherein the specified code is given to the caller within the message.

3. The method as claimed in claim 1 wherein the message notifies the caller that the user is to be disturbed only for urgent telephone calls.

4. The method as claimed in claim 1 wherein the specified code is entered by pressing a sequence of one or more input keys on a keypad of a telephone used to initiate the incoming call.

5. The method as claimed in claim 1 wherein the telephone is a cellular telephone.

6. The method as claimed in claim 1 wherein the step of notifying includes generating a ringing signal.

7. The method as claimed in claim 1 further comprising the step of determining if the telephone is in an automatic mode.

8. The method as claimed in claim 7 further comprising the step of disabling the steps of automatically answering the incoming call, playing a message and notifying the user if it is determined that the telephone is not in the automatic mode.

9. An automatic answering and message apparatus comprising:
a. a first detecting circuit for detecting an incoming telephone call on a telephone;
b. an answering circuit coupled to the detecting circuit for automatically answering the incoming telephone call thereby forming a connection;
c. a memory and playback circuit coupled to the answering circuit for storing a message and playing the message over the connection;
d. a second detecting circuit for detecting if a specified code is entered; and
e. a signal generating circuit coupled to the second detecting circuit for generating a signal notifying a user of the incoming call if the specified code is entered.

10. The automatic answering and message apparatus as claimed in claim 9 wherein the specified code is given to the caller within the message.

11. The automatic answering and message apparatus as claimed in claim 10 wherein the specified code is entered by pressing a sequence of one or more input keys on a keypad of a telephone used to initiate the incoming call.

12. The automatic answering and message apparatus as claimed in claim 9 wherein the user records the message within the memory.

13. The automatic answering and message apparatus as claimed in claim 9 wherein the telephone is a cellular telephone.

14. The automatic answering and message apparatus as claimed in claim 9 further comprising an automatic mode switch for switching between automatic and normal mode, wherein the answering circuit, the memory and playback circuit, the second detecting circuit and the signal generating circuit are only enabled when the automatic mode switch is in the automatic mode.

15. A telephone comprising:
a. a first detecting circuit for detecting an incoming call;
b. an automatic mode switch for switching between automatic and normal mode;
c. an answering circuit coupled to the detecting circuit and to the automatic mode switch for automatically answering the incoming telephone call if the automatic mode switch is in the automatic mode thereby forming a connection;
d. a memory and playback circuit coupled to the answering circuit for storing a message and playing the message over the connection;
e. a second detecting circuit for detecting if a specified code is entered; and
f. a signal generating circuit coupled to the second detecting circuit for generating a signal notifying a user of the incoming call if the specific code is entered.

16. The telephone as claimed in claim 15 wherein the specified code is given to the caller within the message.

17. The telephone as claimed in claim 16 wherein the specified code is entered by pressing a sequence of one or more input keys on a keypad of a telephone used to initiate the incoming call.

18. The telephone as claimed in claim 16 wherein the user records the message within the memory.

19. The telephone as claimed in claim 18 wherein the telephone is a cellular telephone.

20. The telephone as claimed in claim 15 wherein the automatic mode switch is an external switch.

21. The telephone as claimed in claim 15 wherein the automatic mode switch is an internal switch which is programmed by the user.
